(19) United States
(12) Patent Application Publication
(10) Pub. No.: US 2024/0066594 A1
(43) Pub. Date: Feb. 29, 2024

(54) DEVICE AND METHOD FOR POWDER PRODUCTION

(71) Applicant: Amirhossein Bayat, Zanjan (IR)

(72) Inventor: Amirhossein Bayat, Zanjan (IR)

(21) Appl. No.: 18/488,819

(22) Filed: Oct. 17, 2023

Related U.S. Application Data
(63) Continuation-in-part of application No. PCT/IB2022/052442, filed on Mar. 17, 2022.

(30) Foreign Application Priority Data
Apr. 18, 2021 (IR) 14005014000300074

(51) Int. Cl. B22F 9/08

(52) U.S. Cl. CPC B22F 9/082; B22F 2009/088; B33Y 70/00

(57) ABSTRACT

In accordance with some embodiments herein, a method for producing a powder from a material is provided. The material may be melted in a melt furnace to produce a melted material. The melted material may be conducted through a melt nozzle to emit, from the melt nozzle, a melt flow traveling through an atomizing chamber. A plurality of gas flows may be emitted through a plurality of orifices of a gas flow production device towards the melt flow. Collision of at least some of the plurality of gas flows with the melt flow in the atomizing chamber disintegrate the melt flow to produce the powder.

### RELATED APPLICATIONS

This application claims priority to and is a continuation-in-part of International Application Number PCT/IB2022/052442, filed on Mar. 17, 2022, entitled “DEVICE AND METHOD OF GAS JET ATOMIZER WITH PARALLEL FLOWS FOR FINE POWDER PRODUCTION”, which claims priority to Iran Application Number 140050140003000747, filed on Apr. 18, 2021. International Application Number PCT/IB2022/052442 and Iran Application Number 140050140003000747 are incorporated herein by reference in their entirety.

### BACKGROUND

In an atomizing process, a melt may be converted to fine droplets, and the droplets may be solidified to produce a powder. The powder may be used in various applications, such as production of plastic metallic and/or ceramic parts, 3D printing, etc.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A illustrates a powder production system, according to some embodiments.

FIG. 1B illustrates a perspective view of a powder production system, according to some embodiments.

FIG. 2 illustrates front view representations of exemplary showerheads of a gas flow production device, according to some embodiments.

FIG. 3 illustrates exemplary cross-sectional view representations of gas flow arrangements relative to a melt flow, according to some embodiments.

FIG. 4 illustrates a plurality of conduits of a gas flow production device, according to some embodiments.

FIG. 5 illustrates side view representations of directions of a plurality of gas flows relative to a direction of a melt flow, in accordance with some embodiments.

FIG. 6 illustrates representations of collision surfaces associated with collisions between a melt flow and a gas flow in some gas jet atomizers.

FIG. 7A illustrates a first example front view representation of a plurality of gas flows relative to a melt flow and/or a showerhead, in accordance with some embodiments.

FIG. 7B illustrates a second example front view representation of a plurality of gas flows relative to a melt flow and/or a showerhead, in accordance with some embodiments.

FIG. 8 illustrates a particle size distribution data structure representative of a distribution of particle sizes of a powder relative to various target particle size ranges for various applications, in accordance with some embodiments.

FIG. 9 illustrates a flow chart presenting a method for producing a powder from a material, in accordance with some embodiments.

### DETAILED DESCRIPTION

The following subject matter may be embodied in a variety of different forms, such as methods, devices and/or systems. Accordingly, this subject matter is not intended to be construed as limited to any example embodiments set forth herein. Rather, example embodiments are provided merely to be illustrative.

All numerical values within the detailed description and the claims herein are modified by “about” or “approximately” the indicated value, and take into account experimental error and variations that would be expected by a person having ordinary skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. Ranges from any lower limit to any upper limit are contemplated. The upper and lower limits of these smaller ranges which may independently be included in the smaller ranges are also encompassed within the disclosure, subject to any specifically excluded limit in the stated range. Where the stated range includes one or both of the limits, ranges excluding either both of those included limits are also included in the disclosure.

Although any methods and materials similar or equivalent to those described herein can also be used in the practice or testing of the present disclosure, the preferred methods and materials are now described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise.

Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

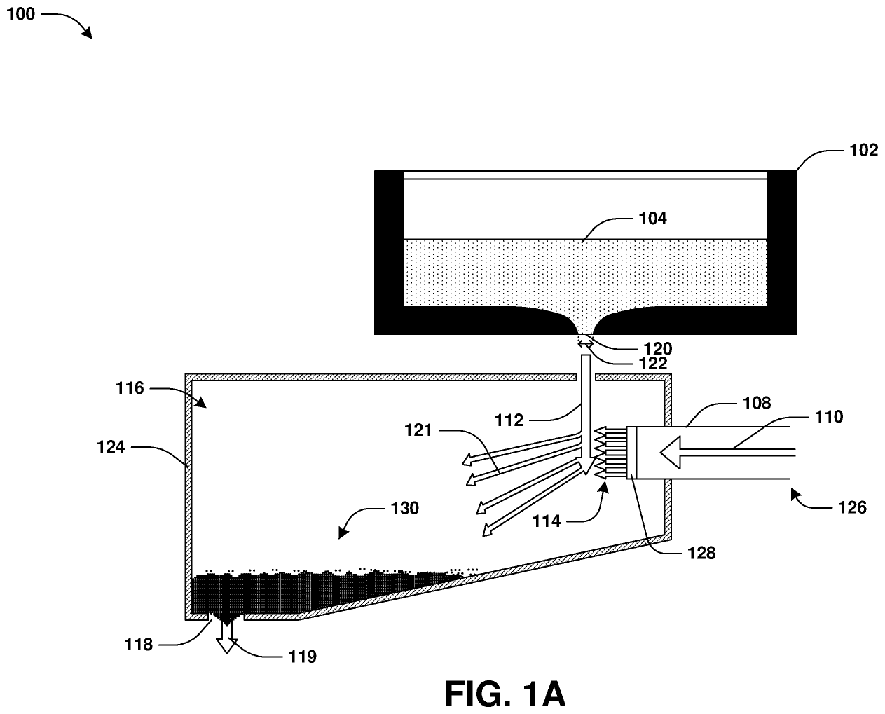

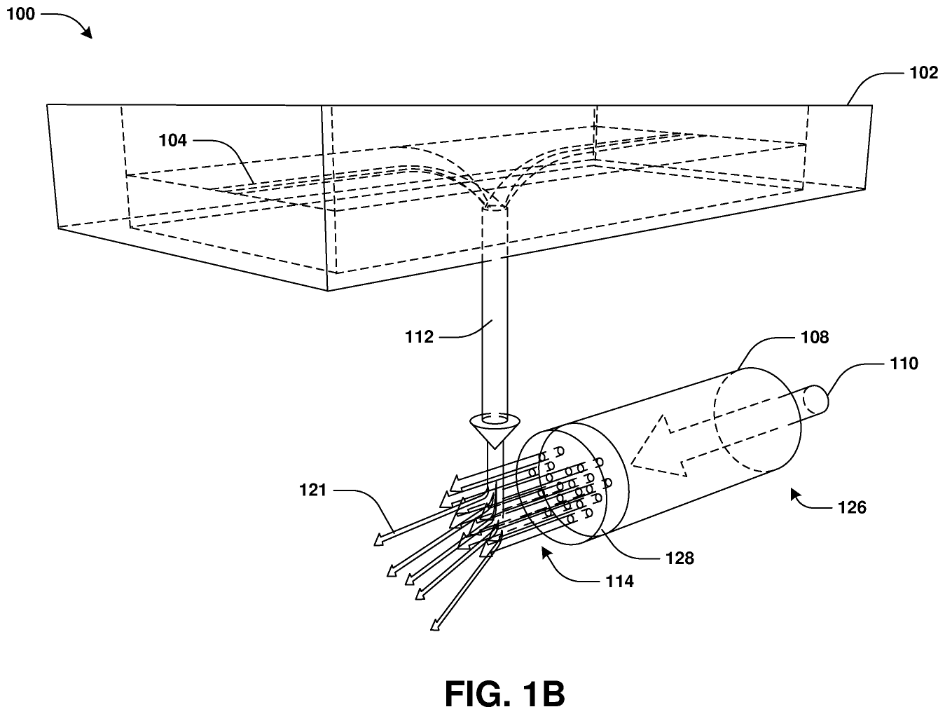

FIGS. 1A-1B illustrate a powder production system 100 according to some embodiments. FIG. 1A illustrates a representation of the powder production system 100 including an atomizing chamber 116. FIG. 1B illustrates a perspective view of at least some of the powder production system 100. With respect to FIG. 1A, the atomizing chamber 116 may be defined by one or more walls 124 (e.g., the one or more walls 124 may at least partially surround the atomizing chamber 116).

In some examples, the powder production system 100 comprises a melt furnace 102 (e.g., tundish) configured to melt a material to produce a melted material 104. In some examples, the material (and/or the melted material 104) comprises one or more plastic materials, one or more polymer materials, one or more metal materials and/or one or more ceramic materials (and/or one or more other suitable materials). In some examples, the melted material 104 is conducted through a melt nozzle 120 to form a melt flow 112 traveling through the atomizing chamber 116. Although FIG. 1A illustrates the melt nozzle 120 to be outside the atomizing chamber 116, embodiments are contemplated in which the melt nozzle 120 is disposed at least partially within the atomizing chamber 116. In some examples, the melt nozzle 120 has a nozzle diameter 122 between at least 1 millimeter to at most 50 millimeters, such as between at least 3 millimeters to at most 15 millimeters. In some examples, the nozzle diameter 122 corresponds to a diameter of an orifice defined by the melt nozzle 120 (e.g., the orifice through which the melt flow 112 is emitted). In some examples, the melt flow 112 comprises a single melt flow (e.g., single stream) and/or may be output via a single orifice defined by the melt nozzle 120. In some examples, the melt flow 112 has a diameter between at least 1 millimeter to at most 50 millimeters, such as between at least 3 millimeters to at most 15 millimeters.

In some examples, the powder production system 100 comprises a gas flow production device 126 to emit a plurality of gas flows 114 (e.g., jet streams and/or jet atomizers) towards the melt flow 112 in the atomizing chamber 116. The gas flow production device 126 may comprise a conduit 108, a showerhead 128, and/or one or more other components. In some examples, collision of at least some of the plurality of gas flows 114 with the melt flow 112 in the atomizing chamber 116 disintegrates the melt flow 112 to produce powder 130. For example, the melt flow 112 may disintegrate into particles 121 (e.g., droplets), which may solidify to form the powder 130. In some examples, the conduit 108 may comprise at least one of a pipe, a tube, a gas channel, etc. In some examples, the gas flow production device 126 emits the plurality of gas flows 114 through a plurality of orifices of the gas flow production device 126 (e.g., each gas flow of the plurality of gas flows 114 is emitted through an orifice of the plurality of orifices). In some embodiments, at least some of the powder 130 may be discharged 119 from the chamber 116 through an exit 118.

In some examples, the gas flow production device 126 feeds a first gas stream 110 (e.g., a continuous gas stream) through a conduit 108. The gas flow production device 126 may comprise one or more pumps (and/or other mechanisms) to generate and/or maintain the first gas stream 110 through the conduit 108. In some examples, the one or more pumps may conduct gas from a gas source to generate the first gas stream 110 in the conduit 108. In some examples, the gas comprises air, nitrogen, water vapor, argon, carbon dioxide and/or helium. In some examples, the first gas stream 110 is generated to have a gas pressure within a first range of gas pressures. In some examples, the first range of gas pressures may range from at least 1 atmosphere to at most 100 atmospheres, and/or may range from at least 1 atmosphere to at most 20 atmospheres.

In some examples, a first direction of a first gas flow of the plurality of gas flows 114 matches a second direction of a second gas flow of the plurality of gas flows 114. For example, the first direction may match the second direction when (i) the first gas flow is about parallel to the second gas flow, and/or (ii) the first direction deviates from the second direction by at most a threshold deviation (e.g., 15 degrees). In some examples, some and/or all gas flows of the plurality of gas flows 114 have directions that match each other (e.g., some and/or all gas flows of the plurality of gas flows 114 share about the same direction). In some examples, the plurality of gas flows 114 may comprise substantially parallel gas flows. In some examples, some and/or all gas flows of the plurality of gas flows 114 are about parallel to each other.

In some examples, the plurality of gas flows 114 are isobaric. In some examples, each gas flow of one, some and/or all of the plurality of gas flows 114 has a constant pressure, and/or some and/or all of the plurality of gas flows 114 share about the same pressure (e.g., a gas pressure within the first range of gas pressures).

In some examples, the plurality of orifices are defined by the showerhead 128 of the gas flow production device 126. In some examples, the showerhead 128 may comprise (and/or may be coupled to) an end of the conduit 108. The plurality of orifices may correspond to holes through the showerhead 128.

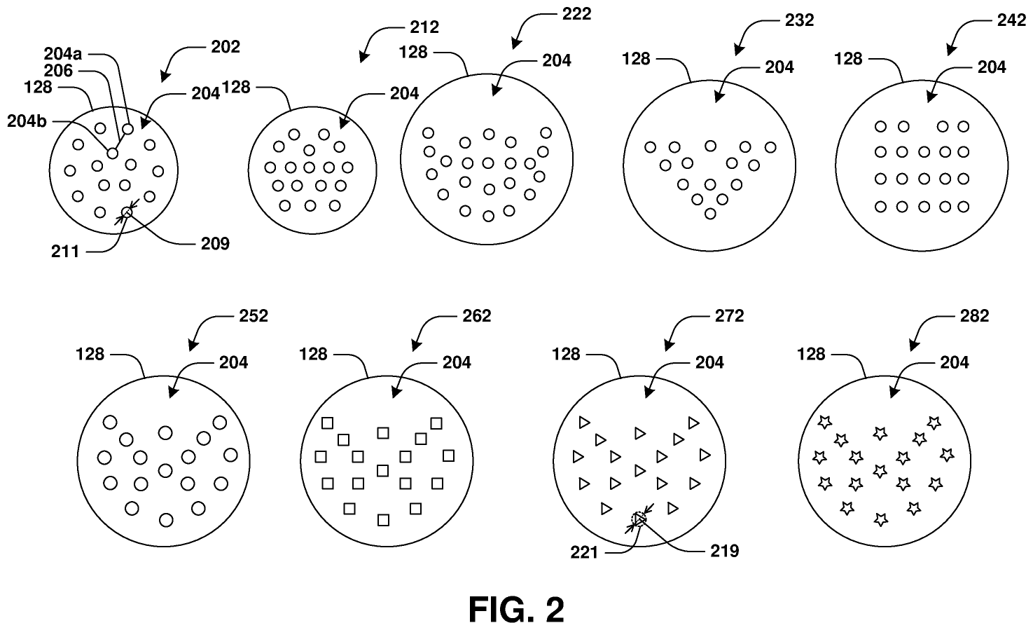

FIG. 2 illustrates front view representations of examples of the showerhead 128 in accordance with some embodiments. In some examples, a cross-sectional shape of an orifice of the plurality of orifices (shown with reference number 204) is at least one of circular, square, rectangular, or polygonal. Any cross-sectional shape of an orifice of the plurality of orifices is contemplated. In some examples, some and/or all of the plurality of orifices 204 share the same cross-sectional shape. In some examples, a cross-sectional area of each orifice of one, some and/or all of the plurality of orifices 204 is between at least 6 square millimeters to at most 200 square millimeters. In some examples, some and/or all of the plurality of orifices 204 share about the same cross-sectional area. In some examples, a quantity of orifices of the plurality of orifices 204 is between at least 2 orifices to at most 1000 orifices, and/or between at least 3 orifices to at most 300 orifices.

In some examples, the plurality of orifices 204 are arranged across the showerhead such that a distance 206 between two adjacent orifices (e.g., orifices 204a and 204b and/or any pair of adjacent orifices of the plurality of orifices 204) is between at least ½\sqrt{p}×D to at most 100\sqrt{p}×D, and/or between at least \sqrt{p}×D to at most 10\sqrt{p}×D. In some examples, D may correspond to a diameter 209 of a circular orifice 211 (in an example in which the showerhead 128 defines circular orifices, for example) or a diameter 219 of a circle 221 surrounding a non-circular orifice (in an example in which the showerhead 128 defines non-circular orifices, for example). In some examples, p may correspond to a working pressure of the gas flow production device 126, which may be within the first range of gas pressures. In some examples, the working pressure may correspond to a gas pressure of the first gas stream 110 and/or a gas pressure of each gas flow of one, some and/or all of the plurality of gas flows 114. For example, if the working pressure is 9 atmospheres and the diameter 209 of the orifice 211 is 1 millimeter, the distance between a pair of adjacent orifices of the plurality of orifices 204 may be between at least 1.5 millimeters to at most 300 millimeters, and/or between at least 3 millimeters to at most 30 millimeters. Alternatively and/or additionally, since a surface (e.g., collision surface) of a high-speed gas flow (e.g., a gas flow of the plurality of gas flows 114, which may correspond to a jet) with the melt flow 112 may be a function of the perimeter of the gas exit orifice (e.g., the orifice 11), by changing shapes of the plurality of orifices 204 (even while keeping the same cross-sectional area, for example) to have more perimeter, more contact surface at the point of collision can be achieved which may ultimately lead to an increase in the efficiency of converting the melt flow 112 into powder particles of the powder 130.

The examples of FIG. 2 include a first example 202 of the showerhead 128, a second example 212 of the showerhead 128, a third example 222 of the showerhead 128, a fourth example 232 of the showerhead 128, a fifth example 242 of the showerhead 128, a sixth example 252 of the showerhead 128, a seventh example 262 of the showerhead 128, an eighth example 272 of the showerhead 128 and/or a ninth example 282 of the showerhead 128. Other examples of the showerhead 128 other than those shown in FIG. 2 are within the scope of the present disclosure. It may be appreciated that the plurality of orifices 204 is not limited to the shapes and/or arrangements shown in FIG. 2. Due to the fact that the showerhead 128 and/or the plurality of orifices 204 can be adjusted (which may have an impact on distances and/or arrangements of the plurality of gas flows 114, for example), the particle size distribution of the produced powder 130 may also be adjusted. It may be appreciated that among orifices of different shapes having the same cross-sectional area, a circular orifice (e.g., orifice 211) may have a smaller perimeter than a perimeter of an orifice having another cross-sectional shape (e.g., square cross-sectional shape, triangle cross-sectional shape, star cross-sectional shape, etc.), and thus the orifice may be defined to have a non-circular cross-sectional shape to provide more collision surface (and/or boundary layer) of the plurality of gas flows 114 with the melt flow 112.

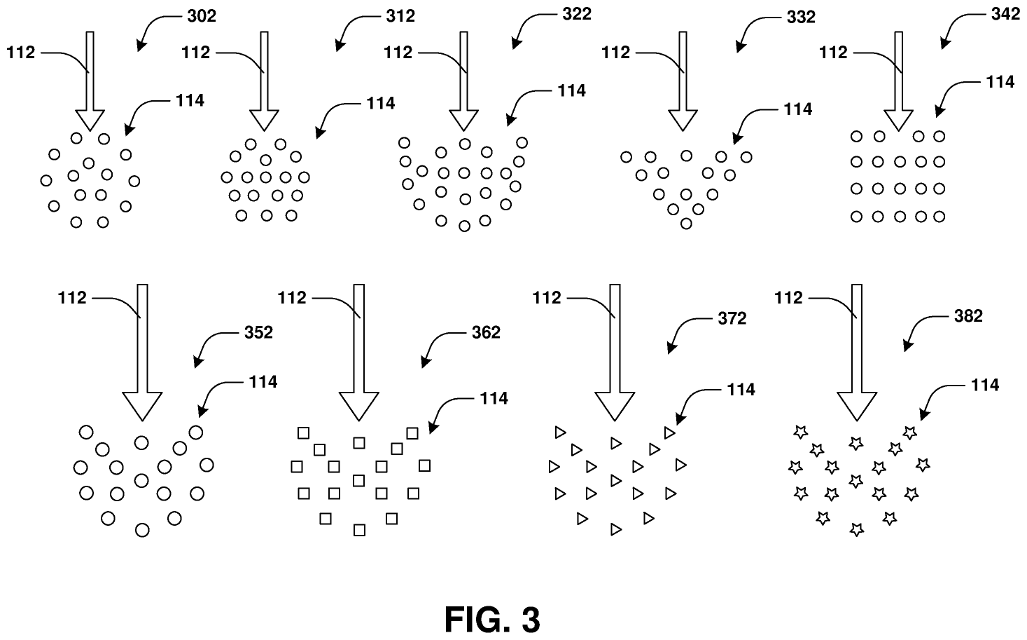

FIG. 3 illustrates cross-sectional view representations of examples of the plurality of gas flows 114 relative to the melt flow 112, in accordance with some embodiments. FIG. 3 includes (i) a first example representation 302 of a cross-sectional view of the plurality of gas flows 114 relative to the melt flow 112 (when the first example 202 of the showerhead 128 is used to generate the plurality of gas flows 114, for example), (ii) a second example representation 312 of a cross-sectional view of the plurality of gas flows 114 relative to the melt flow 112 (when the second example 212 of the showerhead 128 is used to generate the plurality of gas flows 114, for example), (iii) a third example representation 322 of a cross-sectional view of the plurality of gas flows 114 relative to the melt flow 112 (when the third example 222 of the showerhead 128 is used to generate the plurality of gas flows 114, for example), (iv) a fourth example representation 332 of a cross-sectional view of the plurality of gas flows 114 relative to the melt flow 112 (when the fourth example 232 of the showerhead 128 is used to generate the plurality of gas flows 114, for example), (v) a fifth example representation 342 of a cross-sectional view of the plurality of gas flows 114 relative to the melt flow 112 (when the fifth example 242 of the showerhead 128 is used to generate the plurality of gas flows 114, for example), (vi) a sixth example representation 352 of a cross-sectional view of the plurality of gas flows 114 relative to the melt flow 112 (when the sixth example 252 of the showerhead 128 is used to generate the plurality of gas flows 114, for example), (vii) a seventh example representation 362 of a cross-sectional view of the plurality of gas flows 114 relative to the melt flow 112 (when the seventh example 262 of the showerhead 128 is used to generate the plurality of gas flows 114, for example), (viii) an eighth example representation 372 of a cross-sectional view of the plurality of gas flows 114 relative to the melt flow 112 (when the eighth example 272 of the showerhead 128 is used to generate the plurality of gas flows 114, for example), and/or (ix) a ninth example representation 382 of a cross-sectional view of the plurality of gas flows 114 relative to the melt flow 112 (when the ninth example 282 of the showerhead 128 is used to generate the plurality of gas flows 114, for example).

In some examples, such as shown in FIGS. 1A and 1B, the first gas stream 110 (generated to have a gas pressure within the first range of gas pressures, for example) may be conducted through the conduit 108 (e.g., merely the (single) conduit 108) to the showerhead 128 (which defines the plurality of orifices 204, for example) to emit the plurality of gas flows 114 through the plurality of orifices 204. Embodiments are contemplated in which a plurality of gas streams are generated (each having a gas pressure within the first range of gas pressures, for example), and each of the gas streams is conducted through an individual conduit to an orifice of the plurality of orifices 204 to generate a gas flow of the plurality of gas flows 114.

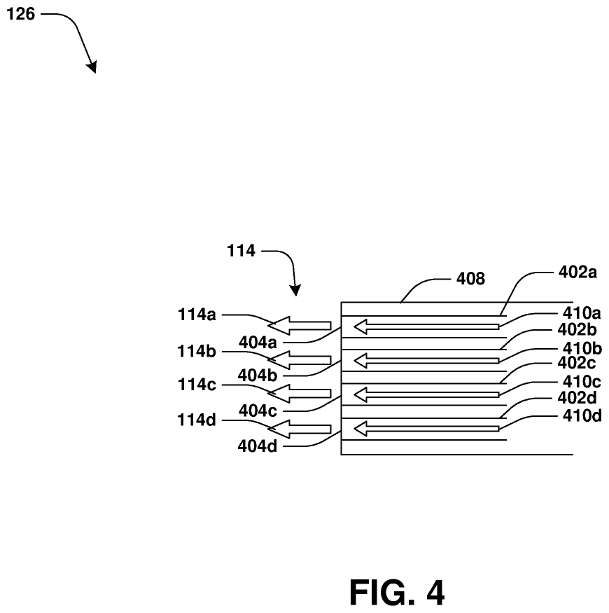

FIG. 4 illustrates an example of the gas flow production device 126 according to some embodiments in which the gas flow production device 126 comprises a plurality of conduits 402 to conduct a plurality of gas streams. In some examples, the plurality of conduits 402 may be disposed within a conduit 408. In some examples, the plurality of conduits 402 may comprise (i) a first conduit 402a to conduct a first gas stream 410a (generated to have a gas pressure within the first range of gas pressures, for example) through an orifice (of the plurality of orifices 204) defined by a first outlet 404a of the first conduit 402a to form a first gas flow 114a of the plurality of gas flows 114, (ii) a second conduit 402b to conduct a second gas stream 410b (generated to have a gas pressure within the first range of gas pressures, for example) through an orifice (of the plurality of orifices 204) defined by a second outlet 404b of the second conduit 402b to form a second gas flow 114b of the plurality of gas flows 114, (iii) a third conduit 402c to conduct a third gas stream 410c (generated to have a gas pressure within the first range of gas pressures, for example) through an orifice (of the plurality of orifices 204) defined by a third outlet 404c of the third conduit 402c to form a third gas flow 114c of the plurality of gas flows 114, (iv) a fourth conduit 402d to conduct a fourth gas stream 410d (generated to have a gas pressure within the first range of gas pressures, for example) through an orifice (of the plurality of orifices 204) defined by a fourth outlet 404d of the fourth conduit 402d to form a fourth gas flow 114d of the plurality of gas flows 114, and/or (v) one or more other conduits (not shown) to conduct one or more other gas streams (generated to have gas pressures within the first range of gas pressures, for example) through one or more orifices (of the plurality of orifices 204) defined by one or more outlets of the one or more other conduits. In some examples, the gas flow production device 126 maintains a gas pressure of each conduit of one, some and/or all of the plurality of conduits 402 to be a gas pressure within the first range of gas pressures.

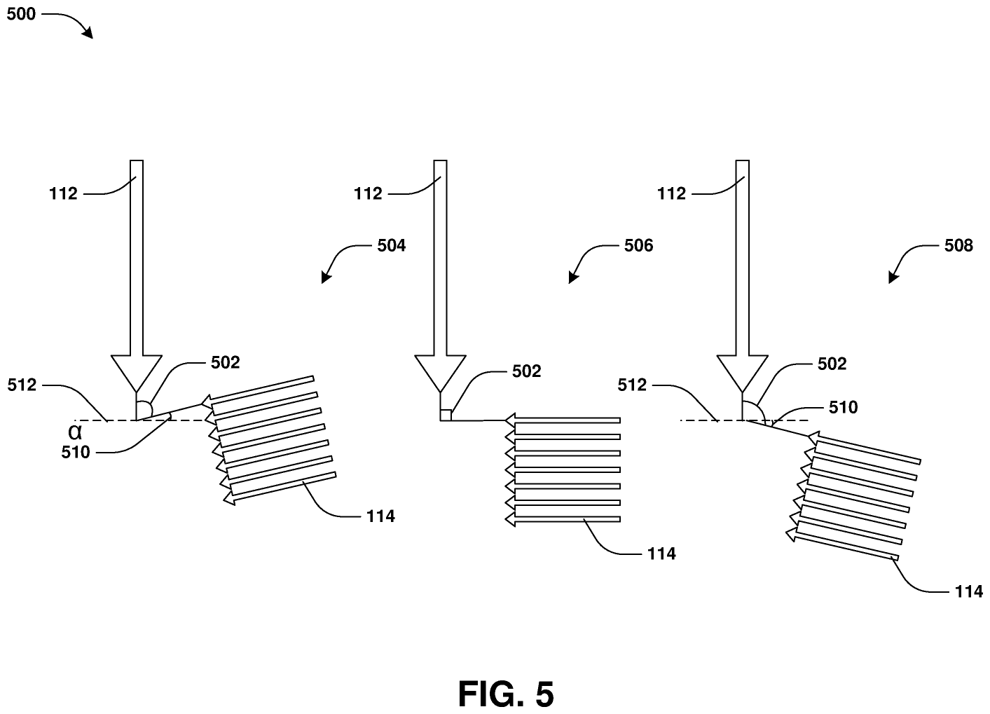

FIG. 5 illustrates side view representations of directions of the plurality of gas flows 114 relative to a direction of the melt flow 112, in accordance with some embodiments. FIG. 5 shows an angle 502 between a direction of a gas flow of the plurality of gas flows 114 and a direction of the melt flow 112. In some examples, the angle 502 is within a first range of angles. In some examples, the first range of angles may range from at least at least 30 degrees to at most 150 degrees, and/or from at least 45 degrees to at most 135 degrees, and/or from at least 75 degrees to at most 105 degrees. In some examples, the angle 502 may be 90 degrees. FIG. 5 includes a first representation 504 when the angle 502 is smaller than 90 degrees, a second representation 506 when the angle 502 is 90 degrees, and/or a third representation 508 when the angle 502 is greater than 90 degrees. In some examples, the direction of the gas flow deviates from a direction 512 by a deviation 510 (e.g., ±45 degrees) (such as shown in the first representation 504 and the third representation 508). In some examples, the direction of the gas flow may be about parallel to the direction 512 in the second representation 506. The direction 512 may correspond to a horizontal direction. The direction 512 may be about perpendicular to the direction of the melt flow 112. In some examples, some and/or all gas flows of the plurality of gas flows 114 have about the same direction.

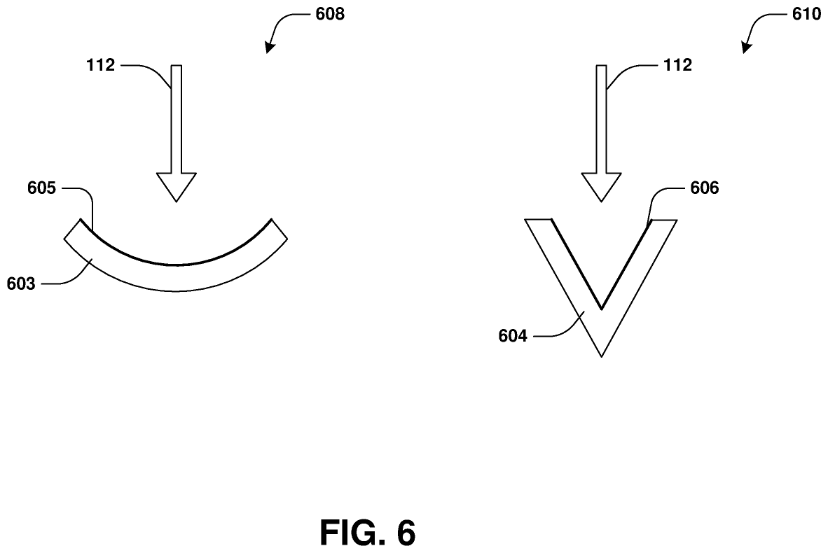

FIG. 6 illustrates representations 608 and 610 of collision surfaces 605 and 606 (characterized with thicker lines in FIG. 6), respectively, associated with collisions between the melt flow 112 and a gas flow (e.g., gas flow 603 and 604) in some gas jet atomizers. As shown in FIG. 6, the collision surfaces may be limited to an upper part of the gas flow (e.g., gas jet ring 603 and gas jet ring 604), thereby providing for limited efficiency with which powder is produced using those gas jet atomizers.

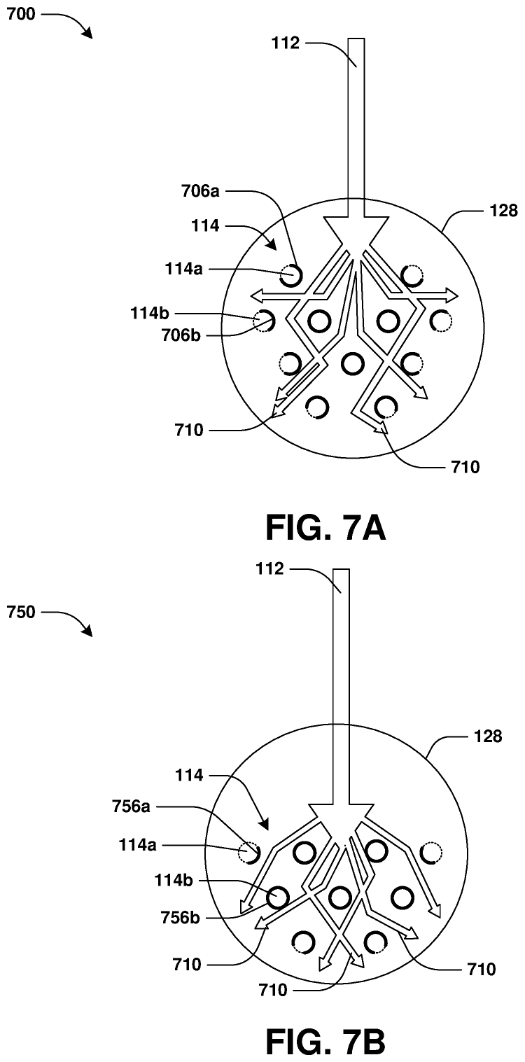

FIG. 7A illustrates a first example front view representation 700 of the plurality of gas flows 114 relative to the melt flow 112 and/or the showerhead 128. Collision surfaces are characterized with thicker lines in FIG. 7A. A collision surface may correspond to a surface of a gas flow which collides with (e.g., impinges upon and/or is in contact with) at least a portion of the melt flow 112 (which may result in disintegrating at least the portion to produce the powder 130, for example). The plurality of gas flows 114 may comprise a first gas flow 114a with a first collision surface 706a (e.g., the first collision surface 706a of the first gas flow 114a may collide with at least some of the melt flow 112, such as a sub-flow 710 of the melt flow 112) and/or a second gas flow 114b with a second collision surface 706b (e.g., the second collision surface 706b of the second gas flow 114b may collide with at least some of the melt flow 112, such as a sub-flow 710 of the melt flow 112). Other example collision surfaces are shown in FIG. 7A. Using the configuration shown in FIG. 7A in accordance with some techniques provided herein provides for an increased amount of collision surfaces and/or collision surfaces being spread out to both upper parts of gas flows and lower parts of gas flows, thereby providing for increased efficiency with which the powder 130 is produced using the techniques of the present disclosure.

FIG. 7B illustrates a second example front view representation 750 of the plurality of gas flows 114 relative to the melt flow 112 and/or the showerhead 128 in accordance with some embodiments. Collision surfaces are characterized with thicker lines in FIG. 7B. The plurality of gas flows 114 may comprise a first gas flow 114a with a first collision surface 756a (e.g., the first collision surface 756a of the first gas flow 114a may collide with at least some of the melt flow 112, such as a sub-flow 710 of the melt flow 112) and/or a second gas flow 114b with a second collision surface 756b (e.g., the second collision surface 756b of the second gas flow 114b may collide with at least some of the melt flow 112, such as a sub-flow 710 of the melt flow 112). The second collision surface 756b may surround (e.g., may span an entire outer surface of) the second gas flow 114b. Other example collision surfaces are shown in FIG. 7B.

Using the configurations shown in FIGS. 7A-7B in accordance with some techniques provided herein provides for an increased amount of collision surfaces and/or collision surfaces being spread out to both upper parts of gas flows and lower parts of gas flows, thereby providing for increased efficiency with which the powder 130 is produced using the techniques of the present disclosure. As shown in FIGS. 7A-7B, the plurality of gas flows 114 may separate the melt flow 112 into sub-flows 710 (e.g., portions of the plurality of gas flows 114), which may comprise droplets of the melt. Thus, the present disclosure may provide for reduced production of coarse particles (e.g., particles with particle sizes above a threshold, such as 100 microns or other threshold) and/or an increased production of fine particles (e.g., particles with particle sizes below a threshold, such as 100 microns or other threshold) (and/or particles with a greater proportion of fine particles and/or a smaller proportion of coarse particles), such as due at least in part, to the increased collision surfaces to produce the powder 130.

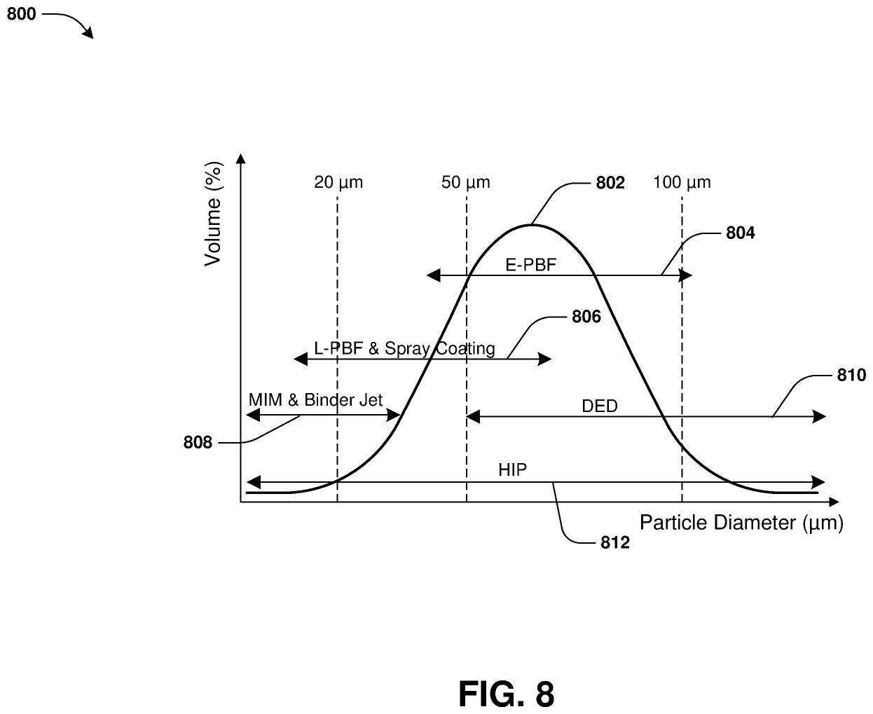

FIG. 8 illustrates a particle size distribution data structure 800 representative of a distribution of particle sizes 802 of a powder relative to various target particle size ranges for various applications (e.g., 3D printing applications), in accordance with some embodiments. The desired particle size ranges include a first target particle size range 804 for Electron-Beam Powder Bed Fusion (E-PBF), a second target particle size range 806 for Laser Powder Bed Fusion (L-PBF) and/or spray coating, a third target particle size range 808 for Metal Injection Molding (MIM) and/or binder jet, a fourth target particle size range 810 for Directed Energy Deposition (DED), and/or a fourth target particle size range 812 for HIP. The particle size distribution data structure 800 of FIG. 8 is reproduced from a figure of article “Metal powders in additive manufacturing: A review on reusability and recyclability of common titanium, nickel, and aluminum alloys “(Moghimian et al., 2021) in Additive Manufacturing journal.

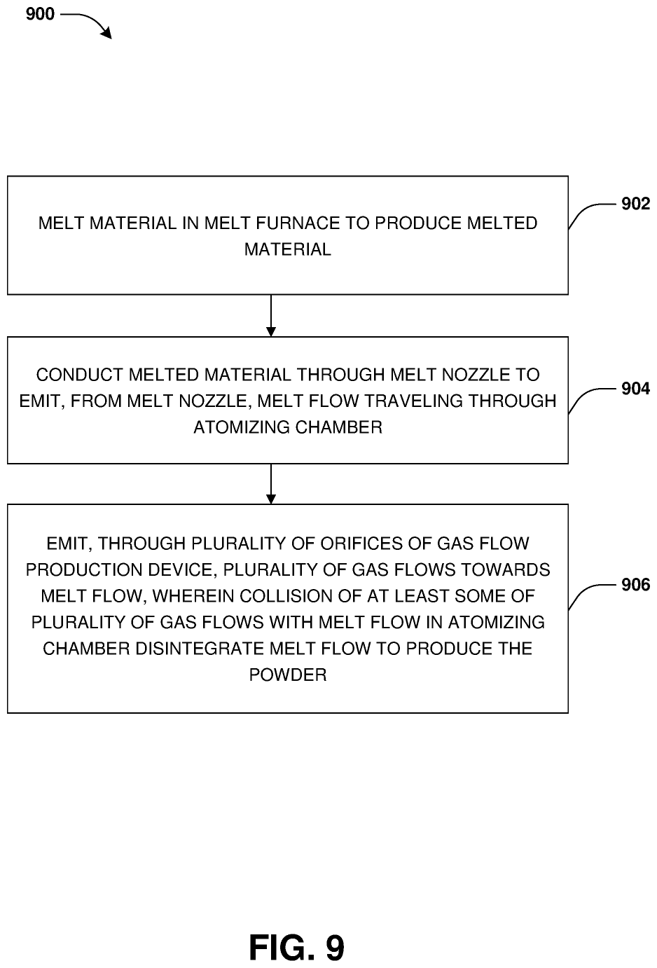

An embodiment for producing a powder from a material is illustrated by an example method 900 of FIG. 9. At 902, the material may be melted in the melt furnace 102 to produce the melted material 104. At 904, the melted material 104 may be conducted through the melt nozzle 120 to emit, from the melt nozzle 120, the melt flow 112 traveling through the atomizing chamber 116. At 906, the plurality of gas flows 114 may be emitted through the plurality of orifices 204 of the gas flow production device 126 towards the melt flow 112. Collision of at least some of the plurality of gas flows 114 with the melt flow 112 in the atomizing chamber 116 disintegrate the melt flow 112 to produce the powder 130.

It may be appreciated that using the techniques provided herein (e.g., emitting the plurality of gas flows 114 towards the melt flow 112 with the angle 502 using the disclosed techniques) may provide for benefits including, but not limited to enabling the powder production system 100 to operate with lower gas pressures (e.g., below 20 atmospheres) to efficiently produce the powder 130, such as due, at least in part, to multiple gas flows being used to impinge upon the melt flow 112 (e.g., which may comprise a single melt flow) to produce the powder 130. Some systems that do not use the techniques of the present disclosure may require higher gas pressures (e.g., greater than 20 atmospheres) than the powder production system 100. Alternatively and/or additionally, the techniques provided herein (e.g., emitting the plurality of gas flows 114 towards the melt flow 112 with the angle 502 using the disclosed techniques) may provide for benefits including, but not limited to enabling the powder production system 100 to operate with relatively inexpensive gases (e.g., air, water vapor, etc.), whereas some systems that do not use the techniques of the present disclosure may require expensive gases (e.g., helium, etc.).

It may be appreciated that a greater proportion of the powder 130 produced by the powder production system 100 using the techniques provided herein are smaller than a target particle size (e.g., 100 microns, 50 microns, 20 microns, etc.) as compared to powders produced without the techniques herein. Other systems may produce powder with a wider array of sizes, and may produce a relatively large amount of powder with particle sizes larger than the target particle size. Alternatively and/or additionally, the powder 130 produced using the techniques provided herein may have a narrower particle size distribution (e.g., particle sizes of particles of the powder may have greater uniformity) as compared to powders produced without the techniques herein. Further, the techniques provided herein may provide for increased quality of morphology of the produced powder 130, with improved and/or more uniform spherical shapes of particles of the powder 130, a reduced quantity of satellite particles and/or a reduced quantity of non-spherical particles in the powder 130. Alternatively and/or additionally, due to the flexible structure of aspects of the powder production system 100, the particle size distribution can be adjusted to desired ranges. Alternatively and/or additionally, in the present disclosure, due to the ability to work at low pressures and/or with relatively inexpensive gases, the operating cost of gas atomization may be greatly reduced.

The present disclosure may be considered in the technical field of powder production from melt in the gas atomization method and involves a wide range of materials such as metal powders (both ferrous and non-ferrous metals), ceramic and refractory powders, and polymer material powders, and it may enable producing powders in high volumes and with an efficiency of more than 99% in particles with a diameter less than 100 microns and with desired morphology (spherical and irregular), as well as with narrow and desired particle size distribution which is able to work in low gas pressures and there is no need for using expensive gases.

In atomizing methods, melt may be converted to fine droplets, and then the droplets are solidified and the powder is produced.

In the gas atomizing method, gas flow may be exerted to disintegrate the melt and convert it into powder and the diameter of the produced particles is less than 500 microns. In the patents CN108274013A, CN103658667B, and CN111299601A some designs of this method are presented which are more or less similar to each other: In a vertical system, the angular collision of gas flow with melt flow from two or more directions may be used to convert the melt into powder. The nozzle orifice for gas atomizing may be circular.

In the gas atomization method, the produced particles may be spherical, but in the existing methods of gas atomization, due to the bonding of molten particles to each other and rapid solidifying of them, irregular, satellite, and non-spherical particles may be created and therefore the efficiency and the quality of particle morphology in the production of spherical particles is reduced greatly. Therefore, various methods have been proposed to improve the particle morphology in the gas atomization method.

For example, in patent No. CN111299601A, a method has been disclosed to reduce the collision bonding probability between molten droplets by direct flow, which resulted in an improved size and shape of the powder particles. In patent No. CN109482893A, to prevent particles from bonding, the atomized particles were charged which produces more regular shapes and prevents the generation of satellite powder effectively. However, none of these methods has solved the problem of the production efficiency of micronized spherical particles in the range of less than 100 microns and none of them mentioned the limiting of the particle size distribution range of the powder.

A desired and well-balanced mixture of fine powder and coarse powder may be important in some applications, and some patents address this issue. In patent No. 20040045404A1, for the production of zinc powder, in order to reduce the cost and achieve the desired mixture of fine and coarse powder in the battery industry by eliminating the sieving and mixing steps of the powder and creating the desired particle size distribution, a process is presented in which multiple nozzles are arranged in parallel (e.g., 2-4 nozzles) at an angle of 90 degrees with multiple melt nozzles (e.g., 2-4 nozzles).

In accordance with some embodiments of the present disclosure, for one or more atomizer nozzles, a single molten metal stream is proposed, in which the pressure of the atomizer nozzles and the flow rate of the molten metal stream are adjusted to match each other (e.g., at least two atomizer nozzles and/or two molten metal streams may be required). In one proposed implementation, low-pressure atomizer nozzles are coupled with low-flow-rate molten metal stream to produce coarse particles (100+ mesh), and high-pressure atomizer nozzles are coupled with high-flow-rate molten metal stream to produce fine particles (−200 mesh) and these processes are carried out concurrently (e.g., simultaneously) in an individual atomizing chamber.

As a result, the production of fine and coarse particles may be performed concurrently (e.g., at the same time) and/or in desired quantities and the produced product may have a stable quality in the characteristics of the mixture of fine and coarse particles. In some examples, the cross-section of the orifice (e.g., an orifice of the plurality of orifices 204) of each atomizer nozzle may be in various shapes of V, U, X or curved, which controls the particle size distribution. Techniques of the present disclosure may solve the problem of powder with a desired combination of fine and coarse particles.

In order to achieve fine particle sizes and a limited and/or desired particle size distribution, there is a need for sieving processes of particles with a diameter outside the desired range, and only a small part of the produced powder will have the desired grades and this leads to a significant increase in production costs, and this problem has not been solved. It may be appreciated that this problem may be solved by using the powder production system 100 in accordance with the techniques provided herein.

Another issue is to increase the collision surface of the melt flow and the gas flow, and as a result, increasing the boundary layers in the collision of these two flows in order to increase the efficiency of the production of fine particles, which was not the method of any of the aforementioned patents. It may be appreciated that using the powder production system 100 in accordance with the techniques provided herein provides for an increase in collision surfaces between melt flow and gas flows, such as discussed herein with respect to FIGS. 6-7B.

Also, the aforementioned patents do not provide for using isobaric parallel gas flows (e.g., the plurality of gas flows 114) to atomize a single melt stream (e.g., the melt flow 112), and none of them solved the issue of powder particles efficiency in the range of less than 100 microns, less than 50 microns, and/or less than 20 microns, which is an important issue in the total cost of the product in different applications. In some embodiments of the present disclosure, not only particles with a diameter less than 100 microns are produced with an efficiency of 99% and with a narrow and desired particle size distribution, but also the efficiency in producing particles with a diameter less than 50 microns is 90% and in particles with a diameter less than 20 microns 60%.

In addition, due to the production process disclosed herein, satellite particles are not created (or are reduced) and the particles are spherical (e.g., completely spherical), and therefore the quality of morphology and the efficiency in the production of fine spherical powder may also be increased greatly using the techniques of the present disclosure. Also, due to the flexible structure of the production process disclosed in the present disclosure, the particle size distribution can be adjusted to various desired ranges. Alternatively and/or additionally, in the present disclosure, due to the ability to work at low pressures and no need for expensive gases such as helium, the operating cost of gas atomization may be reduced greatly.

Nowadays with the advancement of technology, there is an increasing demand for powders with specific particle size distribution and desired morphology in various industries. For instance, 3D printing, which is considered as the pioneer of the third industrial revolution, requires spherical powder particles with a diameter less than 50 microns in many technologies such as powder bed fusion and binder jetting. Also, in many modern forming methods such as plastic and metal forming in 3D printing, or to produce plastic, metallic and ceramic parts by (MIM, CIM) and HIP methods, using powder with spherical shape and narrow particle size distribution, such as fine particles with a diameter less than 100 microns are very important which is shown in FIG. 8. This may be the case in chemical applications where the chemical analysis of the surface of the powder particles is important. So currently, there is an urgent need for a technology to provide these features with high efficiency in the required ranges and as a result, at lower costs.

Powder production methods include water atomization, centrifugal atomization, and milling, which each may have disadvantages such as high cost, reaction with active substances and damage to the chemical composition of the particle surface, and low efficiency in producing micronized particles in certain ranges. Among these, the gas atomization method may cause the least damage to the chemical composition of the particles surface due to the possibility of using neutral gases, and therefore the produced particles are spherical (the spherical shape of the particles is very important in industry, due to the moving possibility of powder particles in transmission systems).

In the following table, the features, advantages and disadvantages of the gas atomization method are presented:

| | Particle | | | |
|---|---|---|---|---|
| Manufactur- | Size, | Particle | | |
| ing Process | μm | Shape | Advantages | Disadvantage |
| Gas | 0-500 | Spherical | High | Wide PSD |
| Atomization | | Shape | throughput | Low yield of |
| | | | Range of | powder between |
| | | | particle sizes | 20 and 150 μm |
| | | | Only requires | Irregular particle |
| | | | feedstock in | morphology |
| | | | ingot form | Satellites present |

Currently, gas atomization has the ability to produce a spherical powder with particle diameters less than 500 microns, and the powder particle size distribution range is wide, but the efficiency in producing particles with a diameter less than 100 microns is low so that according to the published articles in this regard, the efficiency in some powder production systems may be up to 70% in particles with a diameter less than 100 microns or less, 25% in particles with a diameter less than 50 microns or less, and 11% in particles with a diameter less than 20 microns or less. So, this method creates a wide particle size distribution, and therefore, in order to obtain a powder with a uniform, narrow, and desired particle size distribution, there is a need for different stages of sieving and separating the larger particles (oversize) which due to the waste of raw material in the form of coarse powder particles, only a part of the produced powder can be used, and as a result, it imposes a lot of costs in the production of the desired particle size of the powder. Moreover, in this method, irregular, satellite, and non-spherical particles are created due to the bonding of molten particles to each other, and therefore, the efficiency and quality of spherical morphology are extremely low in the production of spherical particles. Another problem in some gas atomization methods may be high gas pressure requirements (e.g., 50-60 atmospheres), which may cause an increase in operating costs. Moreover, in order to increase the transfer of the energy of the gas to the melt flow and produce finer particles, some gas atomization methods may require expensive gases such as helium to be used, which greatly increases the production costs.

Therefore, one of the goals of the present disclosure is to produce powders with (i) a narrow and/or desired particle size distribution, (ii) with a spherical or irregular morphology, (iii) an increase of the efficiency of powder production in particles with a diameter of 100 microns or less (99% in particle sizes of 100 microns or less, 90% in particle sizes of 50 microns or less and 60% in particle sizes of 20 microns or less), and/or (iv) the ability to adjust the particle size distribution in the desired ranges and as a result, reducing production costs to achieve powder with special characteristics in which the morphology of the particles is improved and the particles are spherical (e.g., completely spherical).

Another goal of the present disclosure may be to reduce operating costs in gas atomization by reducing the working pressure, so that the process proposed in the present disclosure may have the possibility of working at low gas pressures of less than 20 atmospheres, and there may be no requirement to use expensive neutral gases such as helium in gas atomization process and cheaper gases can be used. Therefore, the present disclosure may greatly reduce operating costs.

In some examples, in the atomizing process, upon the collision of the melt flow with the surface of the gas flow, the melt flow is accelerated and/or disintegrated. In the present disclosure, after many experiments it is concluded that the efficiency of converting melt into powder particles is in direct relationship with the surface of the gas flow colliding with the melt flow (e.g., boundary layers), which means that as the boundary layers (e.g., collision surface of high-pressure gas flow with melt flow) increases in an equal air volume, finer and more uniform particles are created, and as a result, the efficiency of converting melt into powder particles may be greatly increased.

In some examples, the higher the level of collision between the melt flow and the gas flow, the higher the energy transfer from the gas with high velocity and kinetic energy to the melt, resulting in more energy to disperse the melt stream and turn it into fine droplets, that are then converted to powder upon cooling.

According to the investigations in some gas atomizers, a gas flow passing through a cross-section colliding with a melt flow is used and hence the contact area for the collision of the melt flow and the gas flow may be limited to the gas jet ring around the melt flow, while the rest of the gas flow surface may no longer have the possibility of colliding with the melt flow and the gas energy may not completely transfer to the melt flow. Therefore, in the present disclosure, an attempt has been made to increase the boundary layers between the melt flow and the gas flow, and as a result, increase their collision surface.

For this purpose, in some embodiments of the present disclosure, a high-velocity isobaric parallel gas flows nozzle (jet atomizer) with multiple gas exits (e.g., the plurality of orifices 204) may be used to convert melt (e.g., the melt flow 112) into powder (e.g., the powder 130). The atomizer nozzle or the part/component that produces parallel gas flows can be a section with multiple orifices with a cross-sectional area between 6 square millimeters to 200 square millimeters, which are placed together in different arrangements that when the high-pressure gas passes through it, it leads to the creation of parallel isobaric streams of atomizing gas (e.g., the plurality of gas flows 114) and/or an increase (e.g., a significant increase) in the boundary layers compared to a single gas flow with an equal volume of the passing gas. Alternatively and/or additionally, the contact surface of the melt flow and the gas flow is continuous in some systems, while in some embodiments of the present disclosure, the contact surface of the gas flow and the melt may be discrete, and as a result, the contact surface of the melt flow and gas flows may be increased (and/or maximized). It should be noted that the parallel gas flows (e.g., the plurality of gas flows 114) may be produced by any method, including parallel pipes (e.g., the plurality of conduits 402) which may each have a cross-sectional area between at least 6 square millimeters to at most 200 square millimeters (e.g., each conduit of one some and/or all conduits of the plurality of conduits 402 may have a cross-sectional area between at least 6 square millimeters to at most 200 square millimeters).

Some advantageous effects of the present disclosure include (i) 99% production efficiency in powder particles of 100 microns diameter or less, (ii) 90% production efficiency in powder particles of 50 microns diameter or less, (iii) 60% production efficiency in powder particles of 20 microns diameter or less, (iv) the possibility of producing spherical and non-spherical powders with the mentioned efficiencies, (v) preventing the creation of satellite and irregular powder particles and/or increasing the quality of particle morphology, (vi) the possibility of producing powder with desired and narrow particle size distribution by changing the process parameters, (vii) possibility of working at low gas pressures (e.g., between 1 and 20 atmospheres), (viii) significant reduction in manufacturing costs due to increased efficiency and as a result more use of raw materials, (ix) significant reduction in operating costs due to 1) elimination of the sieving and mixing stage in accordance with some embodiments, 2) working at low gas pressures in accordance with some embodiments, and/or 3) no requirement for expensive gases such as helium in the atomization process in accordance with some embodiments, (x) possibility of using the powder production system 100 as a horizontal and vertical atomizer (e.g., jet atomizer), and/or (xi) possibility of using the powder production system 100 to produce powder from a wide range of materials, such as metal, ceramic, and polymers powders, and in general any type of material that can be melted.

In accordance with some embodiments, FIGS. 7A-7B illustrate the collision surface of the plurality of gas flows 114 and the melt flow 112 increase almost proportionally to the perimeter of the orifices of the parallel gas flows exits. In accordance with some embodiments, due to the melt flow 112 being surrounded (e.g., completely surrounded by) the plurality of gas flows 114 (such as due to the (high-velocity) gas flows 114 and the resulting forces from the gas flows 114), melt of the melt flow 112 may not be able to escape without colliding with parallel gas flows and while accelerating the melt droplets, the parallel gas flows separate the melt flow 112 into the particles 121 (e.g., the smaller droplets), therefore the possibility of creating coarse particles may be minimized, and as a result, the production efficiency in fine particles may be greatly increased.

Alternatively and/or additionally, in some embodiments, parallel flows because of increased bounding layers direct the formed particles in such a way that the probability of the particles colliding with each other and creating satellite powders and so enlarging the particle size is minimized, resulting in smaller and more uniform particles. Alternatively and/or additionally, as it can be seen in FIGS. 7A-7B, collision surfaces of the gas flow with melt flow may be discrete, and as a result, as well as reaching the maximum collision surface between the melt flow 112 and the gas flows 114, the melt flow 112 may be surrounded by the gas flows.

Alternatively and/or additionally, the increase of the boundary layers and the collision surface of the gas flows with the melt flow 112 has resulted reducing a gas pressure requirement (such that there is no need to work at high gas pressures, for example), and as a result, in the techniques of the present disclosure, high efficiencies can be achieved with lower gas pressures (e.g., a gas pressure below 20 atmospheres). Alternatively and/or additionally, the increase of the boundary layers and the collision surface of the gas flows with the melt flow 112 may result in being able to use relatively inexpensive gasses rather than requiring expensive gases such as helium. In some examples, in the gas atomization method and powder production (e.g., metal powders) in order to increase the transfer of gas energy to the melt flow 112, light inert gases such as helium should be used, in which the sound speed and therefore the gas speed is high. But helium gas is very expensive and with the present disclosure, due to the increase in gas energy transferred to the melt flow 112 as a result of parallel gas flows, much cheaper gases may be used in accordance with some embodiments.

In FIG. 1A, in accordance with some embodiments of the present disclosure, different parts of an atomizing system with parallel gas flows are shown which comprises the melt furnace 102 (e.g., which may act as storage for the melted material 104), the melt flow 112 exiting from the melt nozzle 120, the first gas stream 110 (e.g., a continuous gas flow), the conduit 108 (e.g., gas channel) and a jet or the showerhead 128 producing the plurality of gas flows 114, the atomizing chamber 116 for spraying and solidifying, and the exit 118 for powder discharge 119.

In FIG. 1B, in accordance with some embodiments of the present disclosure, the melted material 104, which can be metal, ceramic, or polymer, is melted in the melt furnace 102 which may be equipped with the melt nozzle 120. The first gas stream 110 (e.g., high-speed gas) may pass through the conduit 108 and by passing through the showerhead 128 (e.g., a parallel gas flow production nozzle), the plurality of gas flows 114 (e.g., isobaric high-speed parallel gas flows) are created. In some examples, at the exit of the conduit 108, there is the showerhead 128, in which according to the cross-section of the gas exit orifice, creates the plurality of gas flows 114 (e.g., parallel gas flows). The plurality of gas flows 114 (e.g., parallel gas flows, the gas pressure of which may vary from 1 atmosphere to 20 atmospheres or other gas pressure) may be used to disintegrate the melt flow 112 (e.g., a narrow molten stream), in such a way that the collision surfaces of the melt flow 112 and the plurality of gas flows 114 increase and more energy is transferred to the melt flow 112.

In some examples, as a result of these high-speed independent gas flows hitting the narrow stream of the melt at an angle of e.g., 90±45 degrees, while the melt particles accelerate, very small drops are separated from the melt, which may be solidified (e.g., immediately solidified) in the atomizing chamber 116 due to the heat transfer of the system, resulting in powder particles (e.g., the powder 130). The powder can be discharged through the exit for powder discharge 118.

FIG. 5, in accordance with some embodiments of the present disclosure, illustrates the preference for placing the (gas jet) atomizer nozzle is horizontal and about perpendicular to the melt stream, however, this atomizer nozzle design can be utilized in vertical atomizing systems. In some examples, the angle between parallel gas flows and the melt flow is 90 degrees which has a deviation (e.g., ±45) from the horizontal direction and is shown with the deviation 510 (e.g., a angle) in FIG. 5. The deviation 510 may be a deviation between the axis of the atomizer nozzle with the melt flow 112 which may help to control the flow of atomized particles in the atomizing chamber 116. So, in case of changing the deviation 510 (e.g., collision angle) of the melt flow 112 with the produced gas flows (e.g., less than or more than 90 degrees), other controls can be performed.

In some examples, the deviation 510 (e.g., collision angle) does not have to be 90 degrees, and also supplying the melt flow 112 can be performed from different directions. For instance, considering the suction created by high-velocity gas flows, the melt flow 112 (e.g., melt stream) can be supplied or injected even from the bottom points of the gas flow. The atomizing fluid in the present disclosure like all other methods of gas atomization can be air, steam, carbon dioxide, neutral gases such as nitrogen, argon, helium, natural gas or any other type of gas or a mixture of them which can be chosen according to the cost, thermal conductivity and reactivity with the atomizing material. Of course, as stated, if the choice of gas is to increase the energy transfer of gas to melt and achieve higher efficiency, in the process of the present disclosure, due to the increase of energy transfer of the gas to the melt and as a result increasing the efficiency, there may be no need to use these gases which are usually expensive.

The proposed method in the present disclosure is not only capable of being used in a wide range of materials, but also in this method, the production efficiency of fine spherical particles in particles with a diameter less than 100 microns may be increased to 99%, in particles with a diameter less than 50 microns may be increased to 90%, and in particles with a diameter less than 20 microns may be increased to 60%. In other words, the diameter of almost all the powder particles produced in this method may be less than 100 microns and some and/or all of the particles may be spherical, while the efficiency of the some gas atomizers is 70% in particles with a diameter less than 100 microns, 25% in particles with a diameter less than 50 microns and 11% in particles with a diameter less than 20 microns and non-spherical satellite powders is produced.

As a result, in some embodiments, in order to obtain a powder with a specific particle size distribution, there may be no need to sieve or separate the particles, because some and/or all the melt (e.g., the melt flow 112 and/or raw material) has been converted into powder in the desired ranges. Also in this process, upon changing atomizing parameters such as changing the arrangement, direction, and surface area of these parallel flows, atomizing gas type, fluid pressure and velocity, melt flow diameter and its flow diameter, and the collision angle of parallel gas flows and melt stream, the parameters of the produced particles can be adjusted as desired and obtain a powder with desired morphology and particle size distribution.

The present disclosure covers a wide range of materials including metal powders (both ferrous and non-ferrous metals), ceramic and refractory materials powders and, polymer powders, and additionally, this type of atomizer can be used horizontally and vertically. In the following, the use of this atomizer to produce metal powder in a horizontal atomizer is described.

In an example embodiment, a metal, which can be various ferrous or non-ferrous alloys (such as zinc, copper, silver, aluminum, etc.), is melted in a furnace (induction, arc, or flame furnace) and through a ceramic tundish, a molten stream with a diameter between at least 1 millimeter to at most 10 millimeters may be created. Atomizing gas, which can be air or inert gas, is compressed by a compressor with an air volume between at least 1 cubic meters per minute to at most 40 cubic meters per minute and a pressure between at least 1 atmosphere to at most 20 atmospheres, and through the passage from the atomizer nozzle (e.g., through the plurality of orifices 204), high-velocity isobaric parallel gas flows (e.g., the plurality of gas flows 114) are created. By colliding these flows with the melt flow horizontally and at an angle of 90±45 degrees, melt droplets are formed and solidify in the atomizing chamber and then collected by one or more particle collection systems such as cyclones, bag filters, etc.

By using the present disclosure, the production of various materials powder with a diameter less than 100 microns (in specific and desired ranges), and in different morphologies of spherical, and irregular is possible. In the following, some of the applications of these materials are mentioned.

In the field of metal powders: (i) powder metallurgy industry: Powder of various ferrous and non-ferrous alloys has a wide range of applications in the manufacture of industrial parts, such as in the manufacture of complex parts with precise dimensional control, (ii) methods of manufacturing parts: technologies for manufacturing metal parts such as additive manufacturing (3D printing), metal injection molding, or to produce plastic, metallic and ceramic parts by (MIM, CIM) and HIP methods require fine powders in a narrow particle size distribution to reduce production costs, (iii) welding and electrode industries: powders of various ferrous alloys and some non-ferrous metals are considered as filler metals or energy sources, (iv) military industries: powders of some metals such as aluminum and magnesium are considered as a fuel and energy source, and/or (v) renewable energy industries: solar cells and new batteries are just examples of metal powders' application in the field of energy.

In the field of ceramic powders: (i) rock wool and ceramic wool can be produced by this technology, and/or (ii) special thermal insulation such as bubble alumina.

In the field of polymer powders: (i) printing toner manufacturing industry, and/or (ii) wax manufacturing industry.

Some gas atomization methods have low efficiency, and the produced particles are non-spherical. In some embodiments of the present disclosure, to solve these problems, the concept of the boundary layer and/or the collision of isobaric parallel gas flows at an angle of 90±45 degrees with the melt flow (with a diameter between 3-15 millimeters, for example) may be used to disintegrate the melt and produce powder. The arrangement, orientation, and shape (with a cross-sectional area between at least 6 square millimeters to at most 200 square millimeters, for example) of the orifices of the component can be changed and it's possible to achieve powder with desired particle size distribution.

According to some embodiments, a method for producing a powder from a material is provided. The method includes: melting the material in a melt furnace to produce a melted material; conducting the melted material through a melt nozzle to emit, from the melt nozzle, a melt flow traveling through an atomizing chamber; and emitting, through a plurality of orifices of a gas flow production device, a plurality of gas flows towards the melt flow, wherein collision of at least some of the plurality of gas flows with the melt flow in the atomizing chamber disintegrate the melt flow to produce the powder.

According to some embodiments, an angle between a direction of a gas flow of the plurality of gas flows and a direction of the melt flow is between at least 45 degrees to at most 135 degrees.

According to some embodiments, the melt nozzle has a nozzle diameter between at least 3 millimeters to at most 15 millimeters.

According to some embodiments, a direction of a first gas flow of the plurality of gas flows matches a direction of a second gas flow of the plurality of gas flows.

According to some embodiments, the method includes: generating a first gas stream to have a gas pressure between at least 1 atmosphere to at most 20 atmospheres; and conducting the first gas stream through a conduit of the gas flow production device to one or more orifices of the plurality of orifices to produce one or more gas flows of the plurality of gas flows.

According to some embodiments, the plurality of orifices are defined by a showerhead of the gas flow production device; and the plurality of orifices are arranged across the showerhead such that a distance between two adjacent orifices of the plurality of orifices is at least \sqrt{p}×D, wherein p corresponds to a working pressure of the gas flow production device, and D corresponds to a diameter of an orifice of the plurality of orifices and/or a diameter of a circle surrounding the orifice; and at most 10\sqrt{p}×D.

According to some embodiments, the plurality of gas flows are isobaric.

According to some embodiments, a cross-sectional shape of an orifice of the plurality of orifices is at least one of circular, square, rectangular, or polygonal.

According to some embodiments, a cross-sectional area of an orifice of the plurality of orifices is between at least 6 square millimeters to at most 200 square millimeters.

According to some embodiments, a quantity of orifices of the plurality of orifices is between at least 3 orifices to at most 300 orifices.

According to some embodiments, the melt flow has a diameter between at least 3 millimeters to at most 15 millimeters.

According to some embodiments, the plurality of gas flows comprise at least one of air, nitrogen, water vapor, argon, carbon dioxide, or helium.

According to some embodiments, the method includes: generating a first gas stream in a first conduit of the gas flow production device to have a first gas pressure between at least 1 atmosphere to at most 20 atmospheres, wherein an outlet of the first conduit defines a first orifice of the plurality of orifices; conducting the first gas stream through the first orifice to emit a first gas flow, of the plurality of gas flows, towards the melt flow; generating a second gas stream in a second conduit of the gas flow production device to have a second gas pressure between at least 1 atmosphere to at most 20 atmospheres, wherein an outlet of the second conduit defines a second orifice of the plurality of orifices; and conducting the second gas stream through the second orifice to emit a second gas flow, of the plurality of gas flows, towards the melt flow.

According to some embodiments, a powder production system for producing a powder from a material is provided. The powder production system includes: a melt furnace configured to melt the material to produce a melted material; a melt nozzle configured to emit a melt flow comprising the melted material through an atomizing chamber; and a gas flow production device configured to emit, through a plurality of orifices, a plurality of gas flows towards the melt flow, wherein collision of at least some of the plurality of gas flows with the melt flow in the atomizing chamber disintegrate the melt flow to produce the powder.

According to some embodiments, an angle between a direction of a gas flow of the plurality of gas flows and a direction of the melt flow is between at least 45 degrees to at most 135 degrees.

According to some embodiments, the melt nozzle has a nozzle diameter between at least 3 millimeters to at most 15 millimeters.

According to some embodiments, a direction of a first gas flow of the plurality of gas flows matches a direction of a second gas flow of the plurality of gas flows.

According to some embodiments, the gas flow production device is configured to: generate a first gas stream to have a gas pressure between at least 1 atmosphere to at most 20 atmospheres; and conduct the first gas stream through a conduit to one or more orifices of the plurality of orifices to produce one or more gas flows of the plurality of gas flows.

According to some embodiments, the material comprises at least one of: one or more plastic materials; one or more polymer materials; one or more metal materials; or one or more ceramic materials.

According to some embodiments, the plurality of gas flows are isobaric.

According to some embodiments, a method for producing fine powder particles is provided. The method includes: producing fine powder particles from a melt flow using independent parallel gas flows in gas atomization, in which a component/jet atomizer producing parallel gas flows is used, which is placed in the path of the gas channel and through passing the gas from its orifices, isobaric parallel gas flows are produced, in which upon colliding of these parallel flows with the melt flow, the molten particles pass through the independent parallel gas streams, disintegrate as a result of this collision and after solidifying of the small particles, the powder is produces, and this method includes the following steps: melting of the atomized material in a melt furnace and its exit from a melt nozzle with a diameter of 3 mm to 15 mm; placement of the component that produces parallel gas flows in the gas passage path at an angle of 90±45 degrees with the melt flow so that the parallel gas flows collide with the melt flow; creating a gas pressure of 1-20 atmospheres in the path of gas channel and exiting this flow from the orifices of the component producing parallel flows and creating isobaric parallel gas flows; and collision of the parallel gas flows with the melt flow, which leads to the separation of fine molten particles from each other and the production of powder in the atomizing chamber.

According to some embodiments, the arrangement of the exits of the parallel gas flows in the component producing the parallel streams, the distance between the orifices of the gas exits should not be more than 10\sqrt{p}×D and less than \sqrt{p}×D, where p is the working pressure and/or D corresponds to a diameter of the orifice and/or a diameter of a circle surrounding the orifice.

According to some embodiments, the number of gas exit orifices is between at least 3 to at most 300, the cross section of each of them can be circular, square, rectangular, polygonal, or a combination of them, and the cross-sectional area of each of these orifices is between at least 6 square millimeters to at most 200 square millimeters.

According to some embodiments, the isobaric parallel gas flows can be produced by a part/component with multiple orifices, parallel pipes or any other component that can produce parallel gas flows.

According to some embodiments, the melt flow has a diameter between at least 3 millimeters to at most 15 millimeters and the isobaric parallel gas flows have a pressure in the range of 1-20 atmospheres.

According to some embodiments, the gas used can be air, nitrogen, water vapor, argon, carbon dioxide, helium, and a mixture of the different gases.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for producing a powder from a material, the method comprising:
melting the material in a melt furnace to produce a melted material;
conducting the melted material through a melt nozzle to emit, from the melt nozzle, a melt flow traveling through an atomizing chamber; and
emitting, through a plurality of orifices of a gas flow production device, a plurality of gas flows towards the melt flow, wherein collision of at least some of the plurality of gas flows with the melt flow in the atomizing chamber disintegrate the melt flow to produce the powder.

2. The method of claim 1, wherein:
an angle between a direction of a gas flow of the plurality of gas flows and a direction of the melt flow is between at least 45 degrees to at most 135 degrees.

3. The method of claim 1, wherein:
the melt nozzle has a nozzle diameter between at least 3 millimeters to at most 15 millimeters.

4. The method of claim 1, wherein:
a direction of a first gas flow of the plurality of gas flows matches a direction of a second gas flow of the plurality of gas flows.

5. The method of claim 1, comprising:
generating a first gas stream to have a gas pressure between at least 1 atmosphere to at most 20 atmospheres; and
conducting the first gas stream through a conduit of the gas flow production device to one or more orifices of the plurality of orifices to produce one or more gas flows of the plurality of gas flows.

6. The method of claim 1, wherein:
the plurality of orifices are defined by a showerhead of the gas flow production device; and
the plurality of orifices are arranged across the showerhead such that a distance between two adjacent orifices of the plurality of orifices is:
at least \sqrt{p}×D, wherein:
p corresponds to a working pressure of the gas flow production device; and
D corresponds to at least one of:
a diameter of an orifice of the plurality of orifices; or
a diameter of a circle surrounding the orifice; and
at most 10\sqrt{p}×D.

7. The method of claim 1, wherein:
the plurality of gas flows are isobaric.

8. The method of claim 1, wherein:
a cross-sectional shape of an orifice of the plurality of orifices is at least one of circular, square, rectangular, or polygonal.

9. The method of claim 1, wherein:
a cross-sectional area of an orifice of the plurality of orifices is between at least 6 square millimeters to at most 200 square millimeters.

10. The method of claim 1, wherein:
a quantity of orifices of the plurality of orifices is between at least 3 orifices to at most 300 orifices.

11. The method of claim 1, wherein:
the melt flow has a diameter between at least 3 millimeters to at most 15 millimeters.

12. The method of claim 1, wherein:
the plurality of gas flows comprise at least one of air, nitrogen, water vapor, argon, carbon dioxide, or helium.

13. The method of claim 1, comprising:
generating a first gas stream in a first conduit of the gas flow production device to have a first gas pressure between at least 1 atmosphere to at most 20 atmospheres, wherein an outlet of the first conduit defines a first orifice of the plurality of orifices;
conducting the first gas stream through the first orifice to emit a first gas flow, of the plurality of gas flows, towards the melt flow;
generating a second gas stream in a second conduit of the gas flow production device to have a second gas pressure between at least 1 atmosphere to at most 20 atmospheres, wherein an outlet of the second conduit defines a second orifice of the plurality of orifices; and
conducting the second gas stream through the second orifice to emit a second gas flow, of the plurality of gas flows, towards the melt flow.

14. A powder production system to produce a powder from a material, comprising:
a melt furnace configured to melt the material to produce a melted material;
a melt nozzle configured to emit a melt flow comprising the melted material through an atomizing chamber; and
a gas flow production device configured to emit, through a plurality of orifices, a plurality of gas flows towards the melt flow, wherein collision of at least some of the plurality of gas flows with the melt flow in the atomizing chamber disintegrate the melt flow to produce the powder.

15. The powder production system of claim 14, wherein:
an angle between a direction of a gas flow of the plurality of gas flows and a direction of the melt flow is between at least 45 degrees to at most 135 degrees.

16. The powder production system of claim 14, wherein:
the melt nozzle has a nozzle diameter between at least 3 millimeters to at most 15 millimeters.

17. The powder production system of claim 14, wherein:
a direction of a first gas flow of the plurality of gas flows matches a direction of a second gas flow of the plurality of gas flows.

18. The powder production system of claim 14, comprising:
the gas flow production device is configured to:
generate a first gas stream to have a gas pressure between at least 1 atmosphere to at most 20 atmospheres; and
conduct the first gas stream through a conduit to one or more orifices of the plurality of orifices to produce one or more gas flows of the plurality of gas flows.

19. The powder production system of claim 14, wherein the material comprises at least one of:
one or more plastic materials;
one or more polymer materials;
one or more metal materials; or
one or more ceramic materials.

20. The powder production system of claim 14, wherein:
the plurality of gas flows are isobaric.
